(19) United States
(12) Patent Application Publication
(10) Pub. No.: US 2014/0060584 A1
(43) Pub. Date: Mar. 6, 2014

(54) WASH DEVICE

(71) Applicants: Guy P. Boucher, Wells, ME (US); William C. Whitley, North Berwick, ME (US)

(72) Inventors: Guy P. Boucher, Wells, ME (US); William C. Whitley, North Berwick, ME (US)

(73) Assignee: UNITED TECHNOLOGIES CORPORATION, Hartford, CT (US)

(21) Appl. No.: 13/604,898

(22) Filed: Sep. 6, 2012

(51) Int. Cl. B08B 9/00; B08B 3/04

(52) U.S. Cl. 134/22.1; 134/94.1

(57) ABSTRACT

A part washing device includes an air inlet; a first valve to regulate air coming into the washing device through the air inlet; a liquid inlet; a second valve to regulate liquid entering the washing device through the liquid inlet; a connector to receive air and liquid from the first valve and the second valve; and a tube to receive the liquid and/or air from the connector and direct the air and/or liquid towards a portion of the part.

### BACKGROUND

During the manufacturing and finishing process of complex parts, foreign objects such as metal chips from drilling, wax from casting, grit, glass beads from peening and/or other items can become lodged in the parts. This can happen, for example, due to metal shavings from drilling, This is especially likely in areas such as blind holes, bends, twists and crevices. After manufacture, the parts then must be inspected. If foreign objects are detected, the inspector must remove them or the part may be deemed unusable.

### SUMMARY

A part washing device includes an air inlet; a first valve to regulate air coming into the washing device through the air inlet; a liquid inlet; a second valve to regulate liquid entering the washing device through the liquid inlet; a connector to receive air and liquid from the first valve and the second valve; and a tube to receive the liquid and/or air from the connector and direct the air and/or liquid towards a portion of the part.

A method of cleaning cavities includes directing a flow of air and/or liquid toward a cavity through an outlet of a tube; and regulating the flow through the tube with a first valve connected to an air inlet and a second valve connected to a liquid inlet.

### BRIEF DESCRIPTION OF THE DRAWINGS

FIG. 1 is a perspective view of a wash device.

FIG. 2A shows wash device 10 flushing out a blind hole.

FIG. 2B shows wash device 10 flushing out a hidden cavity.

FIG. 2C shows wash device 10 flushing out a blind cavity.

### DETAILED DESCRIPTION

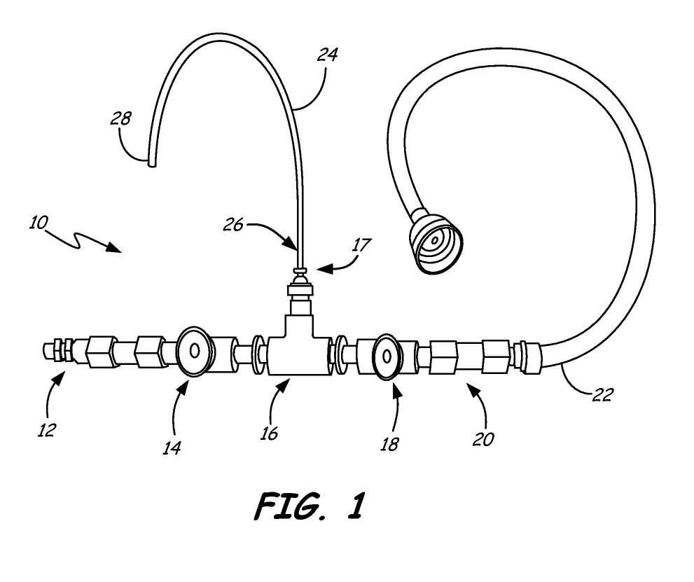

FIG. 1 is a perspective view of wash device 10, including air inlet 12, first valve 14, connector 16 (with outlet 17), second valve 18, liquid inlet 20, hose 22 and tube 24 (with inlet 26 and outlet 28). First valve 14 and second valve 18 can be needle valves. Tube 24 is a rugged, flexible tube and can be made of nylon or other materials to fit into cavities or other small areas that need washing or flushing. Tube 24 must be sturdy enough to withstand and control the force from the liquid and/or air through it and flexible enough to go through bends or twists. Tube 24 must also be sized to fit into small holes or crevices, and, for example, can have a diameter of 1 cm. Connector 16 is a T-shaped connector with two inlets and one outlet 17.

Air inlet 12 is connected to valve 14, which is connected to connector 16. Liquid inlet 20 is connected to second valve 18, which is connected to connector 16. The connections between air inlet 12, first valve 14, connector 16, second valve 18 and liquid inlet 20 can be quick connect fittings or other types of connections depending on system requirements. Connector 16 connects to tube 24 at inlet 26.

Air inlet 12 receives air from a hose (not shown), and liquid inlet 20 receives liquid from hose 22 (which presumably connects to a liquid source, such as a faucet or water tank). First valve 14 controls the flow of air into connector 16, and second valve 18 controls the flow of liquid into connector 26. Connector includes a cavity to receive air and/or liquid and outlet 17 connecting to inlet 26 of tube 24. Air and/or liquid from connector 16 then flows through tube 24, which directs the flow through outlet 28.

As mentioned above, when manufacturing and finishing parts, small portions of metal, grit, and other foreign objects can lodge themselves within parts. This is especially common in complex parts which may include deep crevices, cavities, blind holes, etc. In the past, these parts were inspected, and if a foreign object was found, the inspector would be required to find a way to remove the foreign object or reject the part. The removal was often done with wires or by filling the cavity with liquid. However, neither of these methods were very successful due to the complexity of the parts (and cavities therein) as well as the force with which the objects are lodged.

Wash device 10 uses air and/or water directed through rugged flexible tube 24 to be able to flush out foreign objects from complex parts. The rugged flexible tube 24 allows the air and/or water to be delivered to and directed at very deep or hidden cavities, blind holes, bends, twists and deep crevices which previous methods could not reach. First and second needle valves 14, 18 allow for the use of air, water or both to be able to best deliver what would be most likely to flush the foreign objects out of the specific area in which it is lodged. First and second needle valves 14, 18 can also be opened simultaneously to result in a pulsating wash action through tube 24, providing a hammer-like pressure to dislodge foreign objects. Second needle valve 18 allows for the use of liquid that is not under high pressure, as needle valve 18 can be closed or opened to increase or decrease the pressure of liquid directed from outlet 28 of tube 24.

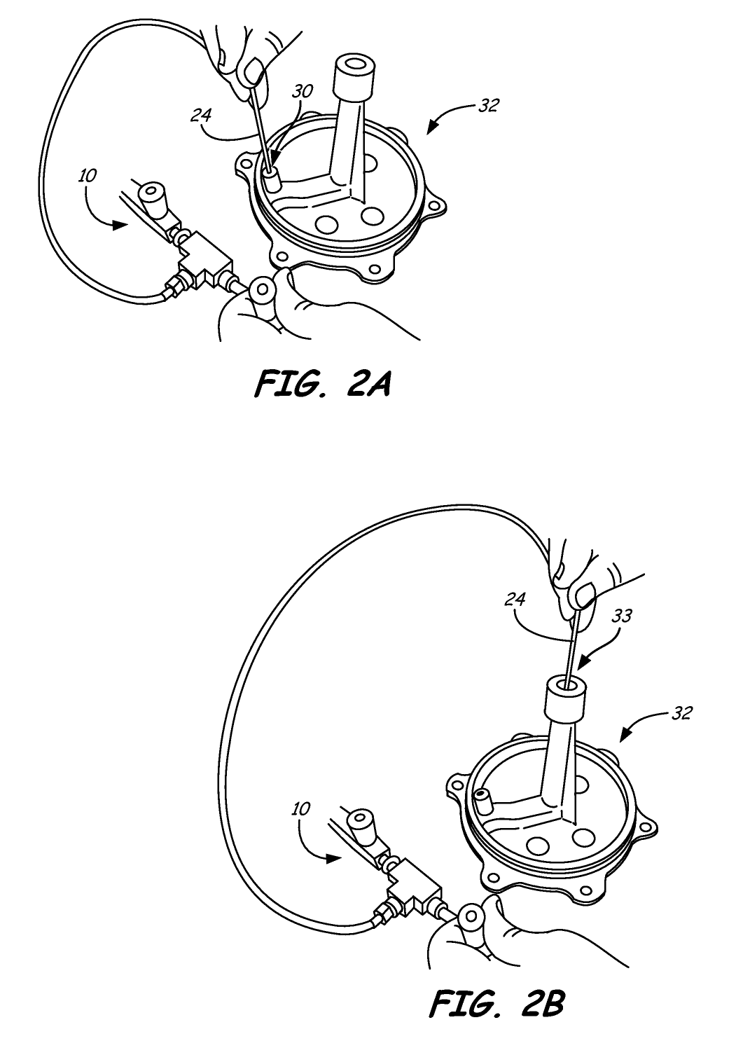

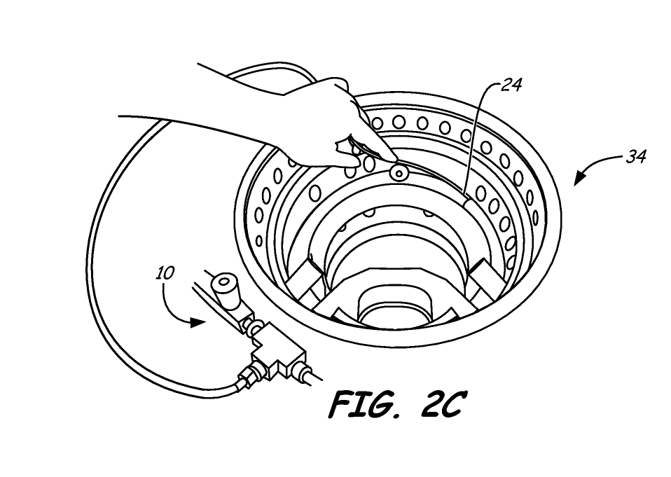

FIG. 2A shows wash device 10 flushing out blind hole 30 in part 32, FIG. 2B shows wash device 10 flushing out deep cavity 33 in part 32, and FIG. 2C shows wash device 10 flushing out a hidden cavity in part 34. Parts 32 and 34 are shown for example purposes only and wash device 10 could be used with any parts that may need washing or flushing.

As can be seen in FIG. 2A and 2B tube 24 is sized and of a flexible, but rugged material, enabling it to be inserted in blind hole 30 or deep cavity 33 to direct air and/or liquid into blind hole 30 and deep cavity 33 where foreign objects are lodged. FIG. 2C shows how tube 24 is able to wind into an arc shaped hidden cavity to dislodge foreign objects which were difficult to reach and dislodge previously.

Wash device 10 is a reliable and effective way to wash foreign objects from deep crevices, blind holes and cavities, bend and twists in part. Tube 24 is able to bend and deliver liquid to small areas that were previously inaccessible. By using first valve 14 for air inlet 12 and second valve 18 for liquid inlet 20, wash device 10 can use air, water or both simultaneously to most effectively flush the part depending on specific needs. When used simultaneously, the air and liquid can work together to form a pulsating wash, acting as a water pick to deliver more dislodging power. Wash device 10 is also small and portable, needing only air and liquid connections, making it easy to use in a shop or in the field.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

What is claimed is:

1. A part washing device comprising:
an air inlet;
a first valve to regulate air coming into the washing device through the air inlet;
a liquid inlet;
a second valve to regulate liquid entering the washing device through the liquid inlet;
a connector to receive air and liquid from the first valve and the second valve; and
a tube to receive the liquid and/or air from the connector and direct the air and/or liquid towards a portion of the part.

2. The part washing device of claim 1, wherein the first valve is a needle valve.

3. The part washing device of claim 1, wherein the second valve is a needle valve.

4. The part washing device of claim 1, wherein the tube is made of a flexible material.

5. The part washing device of claim 1, wherein the tube is nylon.

6. The part washing device of claim 1, wherein the connector is a T-shaped connector.

7. The part washing device of claim 6, wherein each of the air inlet, first valve, connector, second valve and liquid inlets are connected with quick connect fittings, respectively.

8. The part washing device of claim 1, and further comprising a hose connecting to the liquid inlet.

9. The part washing device of claim 1, wherein the first valve and the second valve can regulate the flow of air and liquid into the part washing device so that a pulsating stream of air and liquid exits the tube.

10. A device to direct liquid and/or air a part, the device comprising:
a tube with an inlet and an outlet to direct liquid and/or air at the part;
a connector to deliver the liquid and/or air to the inlet;
an air inlet with a first valve to regulate the flow of air into the connector; and
a liquid inlet with a second valve to regulate the flow of liquid into the connector.

11. The device of claim 10, wherein the first valve and the second valve are needle valves.

12. The device of claim 10, wherein the air inlet with first valve is connected to the connector with a quick connect fitting.

13. The device of claim 10, wherein the liquid inlet with a second valve is connected to the connector with a quick connect fitting.

14. The device of claim 10, and further comprising:
a hose to connect to the liquid inlet and deliver liquid to the liquid inlet.

15. The device of claim 10, wherein the tube is a rugged flexible tube.

16. The device of claim 10, wherein the first valve can regulate the flow of air and the second valve can regulate the flow of liquid so that a pulsating flow of air and liquid exits the tube outlet.

17. A method of cleaning cavities, the method comprising:
directing a flow of air and/or liquid toward a cavity through an outlet of a tube; and
regulating the flow through the tube with a first valve connected to an air inlet and a second valve connected to a liquid inlet.

18. The method of claim 17, wherein the step of regulating the flow comprises:
simultaneously regulating the flow of air through the tube with the first valve and regulating the flow of liquid through the tube with the second valve.

19. The method of claim 18, wherein the air flow and the liquid flow is regulated to result in a pulsating flow directed toward the cavity.

20. The method of claim 17, wherein the first valve and second valve are needle valves.
